(19) United States
(12) Patent Application Publication
(10) Pub. No.: US 2017/0256956 A1
(43) Pub. Date: Sep. 7, 2017

(54) MULTI-IMPEDANCE RECTIFICATION FOR WIRELESS POWER TRANSFER

(71) Applicant: QUALCOMM Incorporated, San Diego, CA (US)

(72) Inventors: Linda Stacey IRISH, San Diego, CA (US); William Henry VON NOVAK, III, San Diego, CA (US); Arvind GOVINDARAJ, San Diego, CA (US); Khoi NGUYEN, San Diego, CA (US)

(21) Appl. No.: 15/061,585

(22) Filed: Mar. 4, 2016

(51) Int. Cl. H02J 5/00; H02J 7/02; H02M 7/217

(52) U.S. Cl. CPC H02J 5/00; H02M 7/217; H02J 7/025

(57) ABSTRACT

A multi-level rectifier is presented that is suitable for use at high frequencies, including into MHz range such as in the 6.78 MHz band used for wireless power transfer. Depending on the amplitude of the input waveform, the rectifier can be operated in different modes. For lower input levels, the rectifier acts as a voltage doubler. For higher input levels, the impedance of the rectifier can be varied based on the input level. The rectifier is a synchronous rectifier with a front section and a back section, where the impedance is varied by changing the phase of the control signal of the back section relative to that of the front section.

### BACKGROUND

Field of the Disclosure

The described technology generally relates to rectifier circuits. More specifically, the disclosure is directed to rectifiers having a variable impedance that are suitable for high frequency operation, such as for devices, systems, and methods related to the receiving of wireless power by a wireless power charging system.

Description of Related Art

Wireless power transfer uses rectifiers to convert a received AC signal to a DC voltage. Wireless power systems see a wide range of coupled voltages into their receiving coil. Previous attempts at working with the wide range of coupled voltages have included use of a switch mode power converter, such as a buck converter, to regulate the output of the coupled voltage. The inductors of buck converters tend to be larger than desired and suffer from AC losses, such as core losses and skin effect, when the switching frequency is increased in an attempt to reduce the inductor size. It would be useful if the rectifier of a wireless power transfer system were to more efficiently handle a range of coupled input voltages.

### SUMMARY

The implementations disclosed herein each have several innovative aspects, no single one of which is solely responsible for the desirable attributes of the invention. Without limiting the scope of the invention, as expressed by the claims that follow, the more prominent features will be briefly disclosed here. After considering this description, one will understand how the features of the various implementations provide several advantages over current wireless transfer systems.

An apparatus for wirelessly receiving power and powering or charging a load includes a receive coupler configured to generate an alternating current (AC) input voltage waveform in response to an externally generated magnetic field. The apparatus further includes a rectifier circuit electrically connected to the receive coupler. The rectifier circuit includes a first switch electrically connected between a first internal node and an input node electrically connected to the receive coupler to receive the input voltage waveform. The rectifier circuit further includes a second switch electrically connected between the input node and a second internal node. The rectifier circuit further includes a third switch electrically connected between the first internal node and a first output node. The rectifier circuit further includes a fourth switch electrically connected between the first output node and the second internal node. The rectifier circuit further includes a fifth switch electrically connected between the second internal node and ground. The rectifier circuit further includes a first capacitor electrically connected between the first internal node and the second internal node. The rectifier circuit further includes a second capacitor electrically connected between the first output node and the load.

A rectification apparatus includes a rectifier circuit comprising a plurality of switches. The rectifier circuit is configured to output a DC output voltage based on an AC input voltage waveform. The rectification apparatus further includes a controller circuit configured to drive the plurality of switches to cause the rectifier circuit to be configured in a first mode as a voltage doubler circuit in response to a voltage level of the input voltage waveform being below a reference voltage. The controller circuit is further configured to drive the plurality of switches to cause the rectifier circuit to be configured in a second mode, different than the first mode, in response to the voltage level of the input voltage waveform being above the reference voltage.

A method of providing a DC output voltage from an AC input voltage waveform includes rectifying the AC input voltage waveform to output the DC output voltage via a rectifier circuit comprising a plurality of switches. The method further includes altering one or more control signals of the plurality of switches to cause the rectifier circuit to be configured in a first mode as a voltage doubler circuit in response to a voltage level of the input voltage waveform being below a reference voltage. The method further includes altering the one or more control signals of the plurality of switches to cause the rectifier circuit to be configured in a second mode, different than the first mode, in response to the voltage level of the input voltage waveform being above the reference voltage.

A rectification circuit includes a control signal circuit and a synchronous rectifier. The control signal circuit is connected to receive an input waveform and generate for it a plurality of control signals. The control signals include a first control signal of a first clock signal and a second control signal of a second non clock signal, where the first clock signal and the second clock signal are non-overlapping clock signals that both have substantially the same frequency as that of the input waveform. The control signals also include a third control signal and fourth control signal. A first switch circuit causes the third control signal to be maintained at a non-clocked high level in response to an input waveform amplitude being less than a reference level and causes the third control signal to be a third clock signal having a frequency substantially equal to a frequency of the input waveform. A second switch circuit causes the fourth control signal to be maintained at a non-clocked low level in response to the input waveform amplitude being less than the reference level and causes the fourth control signal to be a fourth clock signal having a frequency substantially equal to a frequency of the input waveform, wherein the third clock signal and fourth clock signal are non-overlapping and a phase of the third clock signal relative to a phase of the first clock signal is dependent upon the input waveform amplitude. The synchronous rectifier is connected to receive the input waveform and generate therefrom a first output voltage. The synchronous rectifier has a front section, connected to receive the input waveform and the first and second control signals, and a back section, connected to the front section and to receive the third and fourth control signals, and to provide the first output voltage from a first output node.

In a method of providing an output voltage from an input waveform, the input waveform is received at a control signal circuit, which generates control signals. The control signals include a first control signal of a first clock signal and a second control signal of a second clock signal, with the first clock signal and the second clock signal non-overlapping and both having substantially the same frequency as that of the input waveform. The control signals also include a third control signal and fourth control signal. In response to the input waveform having an amplitude less than a reference level, the third control signal is a non-clocked high level and the fourth control signal is a non-clocked low level. In response to the input waveform having an amplitude greater than a reference level, the third and fourth control signal are third and fourth clock signals that are non-overlapping and have substantially the frequency as the input waveform, wherein a phase of the third clock signal relative to a phase of the first clock signal is dependent upon the amplitude of the input waveform. The input waveform and control signals are received at a synchronous rectifier. The synchronous rectifier has a front section, connected to receive the input waveform and the first and second control signals, and a back section connected to the front section and to receive the third and fourth control signals. The synchronous rectifier generates the output voltage from the input waveform in response to the control signals, the first output voltage being provided from the back section of the synchronous rectifier.

A multi-level rectifier includes synchronous rectification means and control signal generating means. The synchronous rectification means is connected to receive an input waveform and generate from it a first output voltage. The synchronous rectification means includes a front section, connected to receive the input waveform and a set of front section control signals, and a back section connected to the front section and to receive a set of back section control signals, where the back section provides the first output voltage. The control signal generating means is connected to receive the input waveform and generate the set of front section control signals and the set of back section control signals. When the input waveform has an amplitude that is less than a reference level the front section of the synchronous rectification means acts as a voltage doubler and the back section of the synchronous rectification means is inactive, and when the input waveform has an amplitude that is more than the reference level the impedance of the synchronous rectification means is a decreasing function of the amplitude of the input waveform.

The following detailed description together with the accompanying drawings will provide a better understanding of the nature and advantages of the disclosure.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with one exemplary embodiment.

FIG. 2 is a schematic diagram of a portion of transmit circuitry or receive circuitry in accordance with exemplary embodiments.

FIG. 3 is a simplified functional block diagram of a transmitter that may be used in an inductive power transfer system, in accordance with exemplary embodiments.

FIG. 4 is a functional block diagram of a receiver that may be used in the inductive power transfer system, in accordance with exemplary embodiments.

FIG. 5 is a schematic diagram of an exemplary embodiment of a synchronous rectifier circuit.

FIG. 6 is a schematic diagram of active elements of the rectifier of FIG. 5 when operating in a low input voltage mode.

FIGS. 7A and 7B respectively are timing diagrams of a set of control waveforms in a low input mode and a high input mode.

FIG. 8 is a plot of a waveform at an IN pin of the rectifier of FIG. 5 operating in the low input voltage mode when the rectifier is acting as a voltage doubler.

FIG. 9 is a plot of the waveform at the IN pin of the rectifier of FIG. 5 operating in the high input mode.

FIG. 10 is a plot of voltage levels for a front section and a back section of the rectifier of FIG. 5 when the two sections are operating 45 degrees out of phase.

FIG. 11 is a plot of variation of the waveform at the input of the rectifier of FIG. 5 as relative phase between front and back control signals is varied.

FIG. 12 is a functional block diagram of a wireless power receiver that includes similar components as FIG. 4 but in a differential implementation.

FIGS. 13A and 13B are schematic diagrams of a differential/single ended dual mode rectifier circuit of FIG. 12 in accordance with an embodiment.

FIG. 14 is a diagram of a flowchart of a method for switching modes of a dual mode rectifier circuit in accordance with an embodiment.

FIG. 15 is a diagram showing exemplary waveforms in accordance with a rectifier mode switching in-band signaling technique showing impedance shifts which can be measured on the transmitter in accordance with an exemplary embodiment.

FIG. 16A is a diagram outlining a rectifier mode switching signaling operation relative to an over voltage threshold.

FIG. 16B is another diagram showing exemplary waveforms in accordance with a rectifier mode switching in-band signaling technique showing impedance shifts which can be measured on the transmitter in accordance with an exemplary embodiment.

FIG. 17 is a diagram showing exemplary waveforms in accordance with a rectifier mode switching in-band signaling technique showing impedance shifts which can be measured on the transmitter in accordance with an exemplary embodiment.

FIG. 18 is a diagram showing exemplary waveforms in accordance with a rectifier mode switching in-band signaling technique showing impedance shifts which can be measured on the transmitter in accordance with an exemplary embodiment.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect. For example, an apparatus may be implemented or a method may be practiced using any number of the aspects set forth herein. In addition, the scope of the following is intended to cover such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless power transfer technologies and system configurations, some of which are illustrated by way of example in the figures and in the following description of the preferred aspects. The detailed description and drawings are merely illustrative of the disclosure rather than limiting, the scope of the disclosure being defined by the appended claims and equivalents thereof.

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

The terminology used herein is for the purpose of describing particular embodiments only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a”, “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “receive coupler” to achieve power transfer.

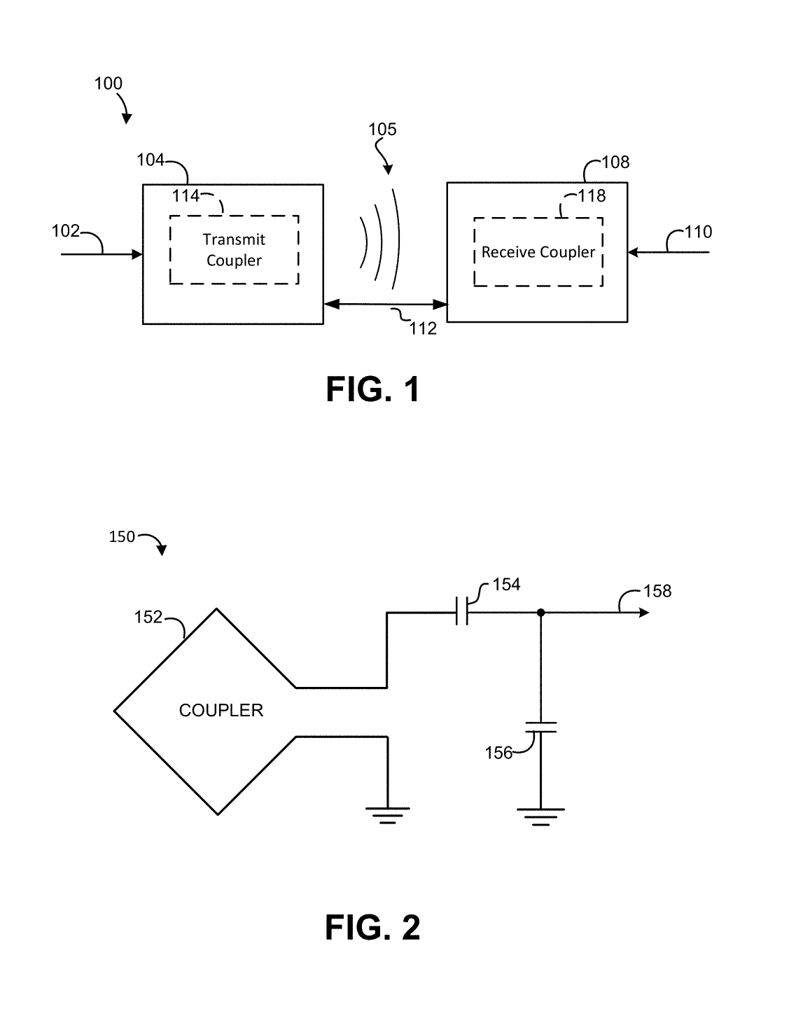

FIG. 1 is a functional block diagram of a wireless power transfer system 100, in accordance with one exemplary embodiment. Input power 102 is provided to a transmit coupler 114 of a transmitter 104 from a power source (not shown in this figure) to generate a wireless (e.g., magnetic or electromagnetic) field 105 for performing energy transfer. A receive coupler 118 of a receiver 108 (e.g., a cellular phone, a GPS unit, a watch, a mobile media device, a laptop computer, a key fob, or the like) couples to the wireless field 105 and generates an output power 110 for storing or consumption by a device (not shown in this figure) coupled to the output power 110. Both the transmitter 104 and the receiver 108 are separated by a distance 112.

The receiver 108 may wirelessly receive power when the receive coupler 118 is located in the wireless field 105 generated by the transmit coupler 114. The transmit coupler 114 of the transmitter 104 may transmit energy to the receive coupler 118 via the wireless field 105. The receive coupler 118 of the receiver 108 may receive or capture the energy transmitted from the transmitter 104 via the wireless field 105. The wireless field 105 corresponds to a region where energy output by the transmit coupler 114 may be captured by the receive coupler 118. In some embodiments, the wireless field 105 may correspond to the “near-field” of the transmitter 104. The “near-field” may correspond to a region in which there are strong reactive fields resulting from the currents and charges in the transmit coupler 114 that minimally radiate power away from the transmit coupler 114 in the far field. The near-field may correspond to a region that is within about one wavelength (or a fraction thereof) of the transmit coupler 114.

In one exemplary embodiment, the wireless field 105 may be a magnetic field and the transmit coupler 114 and the receive coupler 118 are configured to inductively transfer power. The transmit coupler and the receive coupler 118 may further be configured according to a mutual resonant relationship. When the resonant frequency of the receive coupler 118 and the resonant frequency of the transmit coupler 114 are substantially the same or very close, transmission losses between the transmitter 104 and the receiver 108 are reduced. Resonant inductive coupling techniques may thus allow for improved efficiency and power transfer over various distances and with a variety of coupler configurations. When configured according to a mutual resonant relationship, in an embodiment, the transmitter 104 outputs a time varying magnetic field with a frequency corresponding to the resonant frequency of the transmit coupler 114. When the receive coupler 118 is within the wireless field 105, the time varying magnetic field (e.g., externally generated by the transmitter 104) may induce a current in the receive coupler 118. When the receive coupler 118 is configured to resonate at the frequency of the transmit coupler 114, energy may be more efficiently transferred. The alternating current (AC) induced in the receive coupler 118 may be rectified to produce direct current (DC) that may be provided to charge or to power a load (not shown).

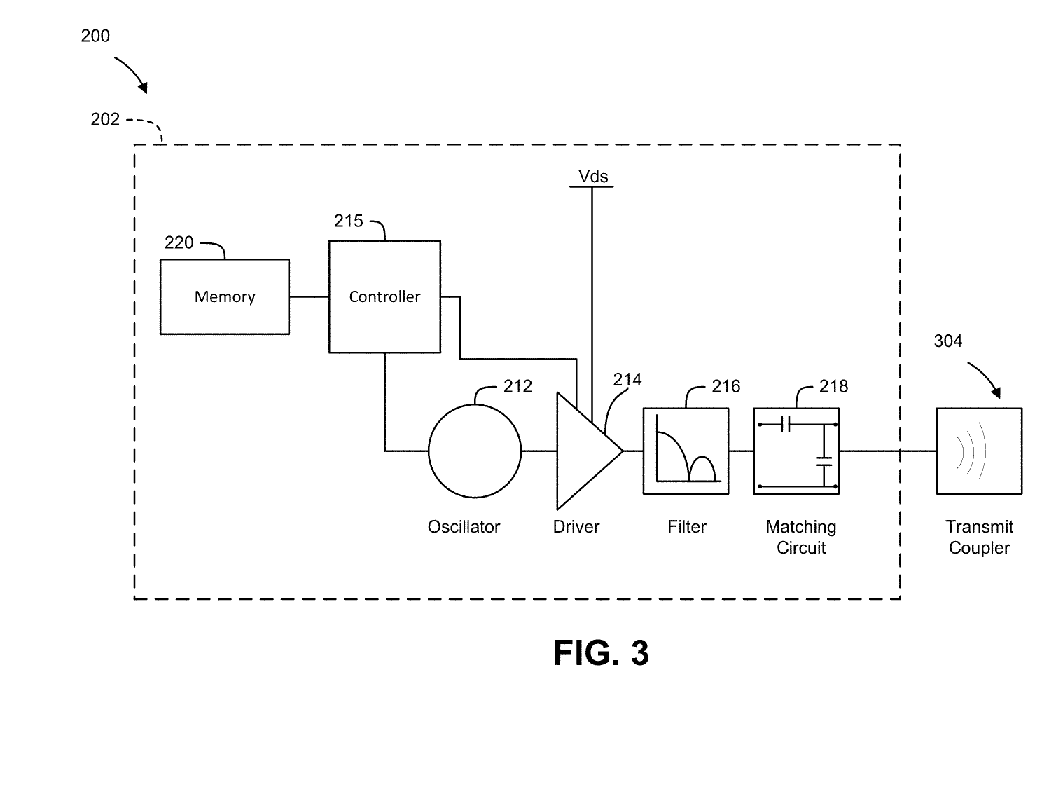

FIG. 2 is a schematic diagram of a portion of transmit circuitry or receive circuitry, in accordance with exemplary embodiments. As illustrated in FIG. 2, the transmit or receive circuitry 250 may include a coupler 252. The coupler 252 may also be referred to herein or be configured as a “magnetic” coupler, an antenna, or an induction coil. The term “coupler” generally refers to a component that wirelessly outputs or receives energy for coupling to another “coupler.” The coupler 252 may also be referred to as a coil or inductor of a type that is configured to wirelessly output or receive power. As used herein, the coupler 252 is an example of a “power transfer component” of a type that is configured to wirelessly output and/or receive power. The coupler 252 may include an air core or a physical core such as a ferrite core (not shown in this figure).

The coupler 252 may form a portion of a resonant circuit configured to resonate at a resonant frequency. The resonant frequency of the coupler 252, which can be a loop coupler or magnetic coupler, is based on the inductance and capacitance. Inductance may be simply the inductance created by the coupler 252, whereas, a capacitor may be added to create a resonant structure at a desired resonant frequency. As a non-limiting example, a capacitor 254 and a capacitor 256 are added to the transmit or receive circuitry 250 to create a resonant circuit that resonates at a desired frequency of operation. Accordingly, for larger diameter couplers, the size of capacitance needed to sustain resonance may decrease as the diameter or inductance of the loop increases. Other resonant circuits formed using other components are also possible.

As another non-limiting example, a capacitor (not shown) may be placed in parallel between the two terminals of the circuitry 250. For transmit couplers, a signal 258, with a frequency that substantially corresponds to the resonant frequency of the coupler 252, may be an input to the coupler 252. For receive couplers, the signal 258, with a frequency that substantially corresponds to the resonant frequency of the coupler 252, may be an output from the coupler 252.

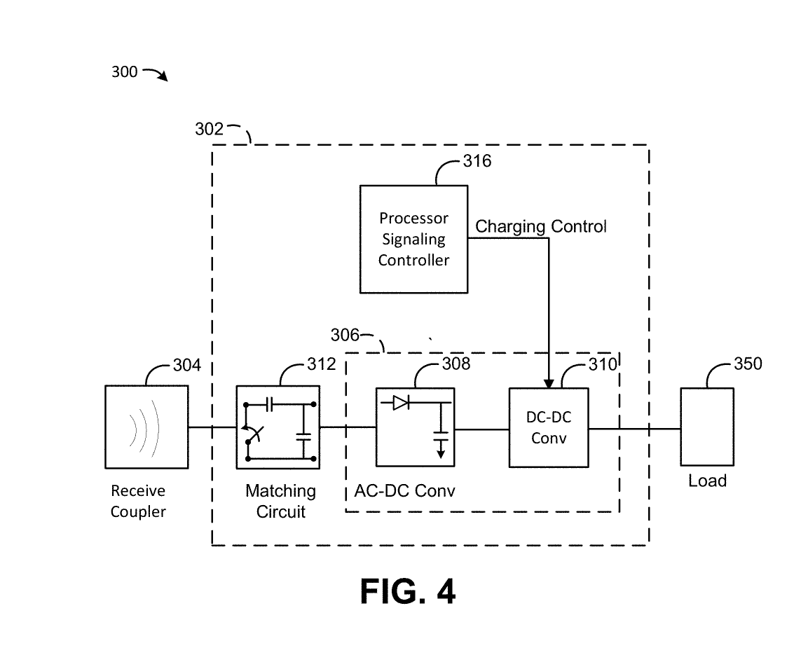

FIG. 3 is a simplified functional block diagram of a transmitter 300 that may be used in an inductive power transfer system, in accordance with exemplary embodiments. The transmitter 300 includes transmit circuitry 302 and a transmit coupler 304 operably coupled to the transmit circuitry 302. In some embodiments, the transmit coupler 304 is or may be referred to as a coil (e.g., an induction coil). In an exemplary embodiment, the transmit coupler 304 is configured to generate an electromagnetic or magnetic field within a charging region. In an exemplary embodiment, the transmit coupler 304 is configured to transmit power to a receiver device within the charging region at a power level sufficient to charge or power the receiver device.

The transmit circuitry 302 may receive power through a number of power sources (not shown). The transmit circuitry 302 may include various components configured to drive the transmit coupler 304. In some exemplary embodiments, the transmit circuitry 302 may be configured to adjust the transmission of wireless power based on the presence and constitution of the receiver devices as described herein. As such, the transmit circuitry 302 may provide wireless power efficiently and safely.

The transmit circuitry 302 includes a controller 315. In some embodiments, the controller 315 may be a micro-controller or a processor. In other embodiments, the controller 315 may be implemented as an application-specific integrated circuit (ASIC). The controller 315 may be operably connected, directly or indirectly, to each component of the transmit circuitry 302. The controller 315 may be further configured to receive information from each of the components of the transmit circuitry 302 and perform calculations based on the received information. The controller 315 may be configured to generate control signals for each of the components that may adjust the operation of that component. As such, the controller 315 may be configured to adjust the power transfer based on a result of the calculations performed by it.

The transmit circuitry 302 may further include a memory 320 operably connected to the controller 315. The memory 320 may comprise random-access memory (RAM), electrically erasable programmable read only memory (EEPROM), flash memory, or non-volatile RAM. The memory 320 may be configured to temporarily or permanently store data for use in read and write operations performed by the controller 315. For example, the memory 320 may be configured to store data generated as a result of the calculations of the controller 315. As such, the memory 320 allows the controller 15 to adjust the transmit circuitry 302 based on changes in the data over time.

The transmit circuitry 302 may further include an oscillator 312 operably connected to the controller 315. The oscillator 312 may be configured to generate an oscillating signal at the operating frequency of the wireless power transfer. For example, in some exemplary embodiments, the oscillator 312 is configured to operate at the 6.78 MHz ISM frequency band. The controller 315 may be configured to selectively enable the oscillator 312 during a transmit phase (or duty cycle). The controller 315 may be further configured to adjust the frequency or a phase of the oscillator 312 which may reduce out-of-band emissions, especially when transitioning from one frequency to another. As described above, the transmit circuitry 302 may be configured to provide an amount of charging power to the transmit coupler 304, which may generate energy (e.g., magnetic flux) about the transmit coupler 304.

The transmit circuitry 302 further includes a driver circuit 314 operably connected to the controller 315 and the oscillator 312. The driver circuit 314 may be configured to drive the signals received from the oscillator 312, as described above.

The transmit circuitry 302 may further include a low pass filter 316 operably connected to the transmit coupler 304. In some exemplary embodiments, the low pass filter 316 may be configured to receive and filter an analog signal of current and an analog signal of voltage generated by the driver circuit 314. In some embodiments, the low pass filter 316 may alter a phase of the analog signals. The low pass filter 316 may cause the same amount of phase change for both the current and the voltage, canceling out the changes. In some embodiments, the controller 315 may be configured to compensate for the phase change caused by the low pass filter 316. The low pass filter 316 may be configured to reduce harmonic emissions to levels that may prevent self-jamming. Other exemplary embodiments may include different filter topologies, such as notch filters that attenuate specific frequencies while passing others.

The transmit circuitry 302 may further include a fixed impedance matching circuit 318 operably connected to the low pass filter 316 and the transmit coupler 304. The fixed impedance matching circuit 318 may be configured to match the impedance of the transmit circuitry 302 (e.g., 50 ohms) to the impedance of the transmit coupler 304. Other exemplary embodiments may include an adaptive impedance match that may be varied based on measurable transmit metrics, such as the measured output power to the transmit coupler 304 or a DC current of the driver circuit 314.

The transmit circuitry 302 may further comprise discrete devices, discrete circuits, and/or an integrated assembly of components.

Transmit coupler 304 may be implemented as an antenna strip with the thickness, width and metal type selected to keep resistive losses low. In one embodiment, the transmit coupler 304 can generally be configured for association with a larger structure such as a table, mat, lamp or other less portable configuration. In an exemplary application where the transmit coupler 304 may be larger in size relative to the receive coupler, the transmit coupler 304 will not necessarily need a large number of turns to obtain a reasonable inductance to form a portion of a resonant circuit tuned to a desired operating frequency.

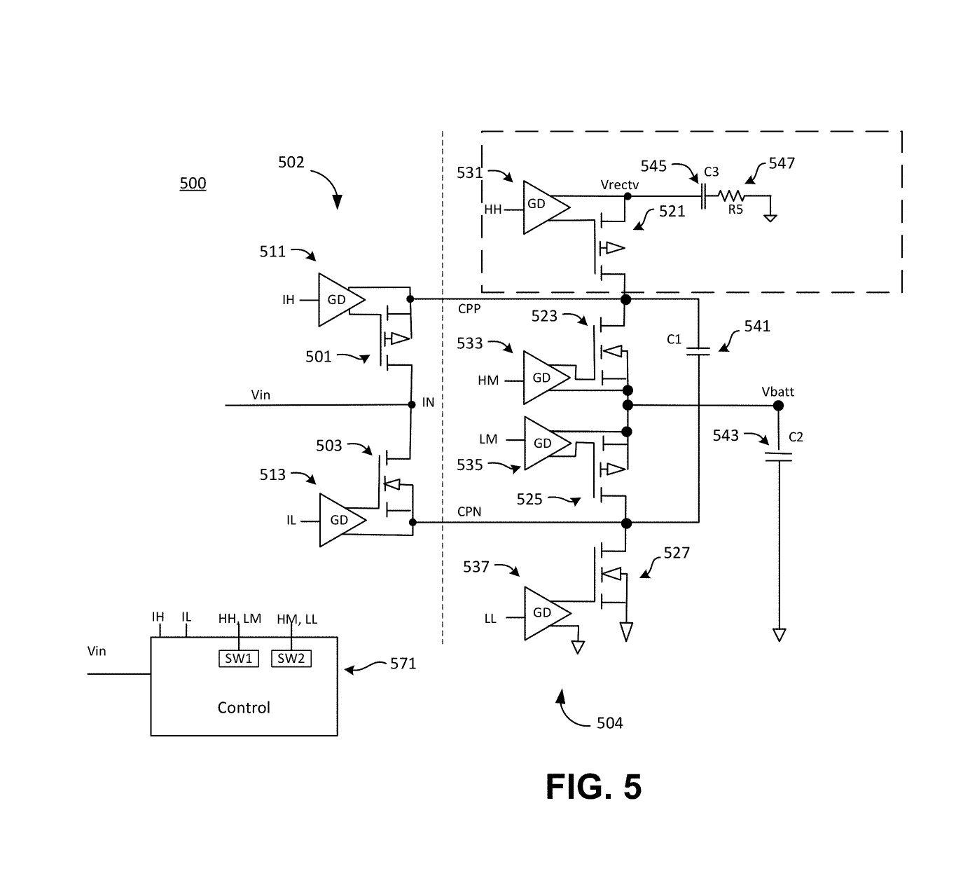

FIG. 4 is an exemplary block diagram of a receiver 400 that may be used in the inductive power transfer system, in accordance with an embodiment. A receiver 400 includes a receive circuitry 402, a receive coupler 404, and a load 450. The receive circuitry 402 is electrically coupled to the load 450 for providing received charging power thereto. It should be noted that receiver 400 is illustrated as being external to load 450 but may be integrated into load 450. The receive coupler 404 is operably connected to the receive circuitry 402. The receive coupler 404 may be configured as the receive coupler 418 as described above in reference to FIG. 2. In some embodiments, the receive coupler 404 may be tuned to resonate at a frequency similar to a resonant frequency of the transmit coupler 304, or within a specified range of frequencies, as described above. The receive coupler 404 may be similarly dimensioned with transmit coupler 304 or may be differently sized based upon the dimensions of the load 450. The receive coupler 404 may be configured to couple to the magnetic field generated by the transmit coupler 304, as described above, and provide an amount of received energy to the receive circuitry 402 to power or charge the load 450.

The receive circuitry 402 is operably coupled to the receive coupler 404 and the load 450. The impedance presented to the receive coupler 404 by the receive circuitry 402 may be configured to match an impedance of the receive coupler 404 (e.g., via a matching circuit schematically represented at 412), which increases efficiency. The receive circuitry 402 may be configured to generate power based on the energy received from the receive coupler 404. The receive circuitry 402 may be configured to provide the generated power to the load 450. In some embodiments, the receiver 400 may be configured to transmit a signal to the transmitter 300 indicating an amount of power received from the transmitter 300.

The receive circuitry 402 includes a processor-signaling controller 416 configured to coordinate the processes of the receiver 400.

The receive circuitry 402 includes power conversion circuitry 406 for converting a received energy source into charging power for use by the load 450. The power conversion circuitry 406 includes an AC-to-DC converter 408 coupled to a DC-to-DC converter 410. The AC-to-DC converter 408 rectifies the AC signal from the receive coupler 404 into DC power while the DC-to-DC converter 410 converts the rectified energy signal into an energy potential (e.g., voltage) that is compatible with the load 450. Various AC-to-DC converters 408 are contemplated including partial and full rectifiers, regulators, bridges, doublers, as well as linear and switching converters.

The receive circuitry 402 may further include the matching circuit 412 configured to connect the receive coupler 404 to the power conversion circuitry 406 or alternatively for disconnecting the power conversion circuitry 406 from the receive coupler 204. Disconnecting the receive coupler 404 from the power conversion circuitry 406 may not only suspend charging of the load 450, but also changes the “load” as “seen” by the transmitter 300 (FIG. 3) as is explained more fully below.

Considering the receive circuitry 402 further, at least a portion of the AC-to-DC converter 408 of FIG. 4 will include a rectifier. Wireless power systems often need to deal with a wide range of coupled voltages into the receive coil. The techniques and circuitry described here present methods that can help to make the receiver more compact and inexpensive. Certain aspects may eliminate or reduce the need for a buck type DC-DC converter or certain components that may be less efficient. The exemplary embodiments allow for the combination of a synchronous rectifier and a charge pump to share transistors. This results in the benefits of synchronous rectification and voltage.

Although the discussion here is presented in the context of wireless power transfer, such as used for wireless battery charging, but can more generally be applied in other applications of rectification where the input waveform is of variable amplitude. For example, these techniques could be applied to off line power converters running at megahertz frequencies.

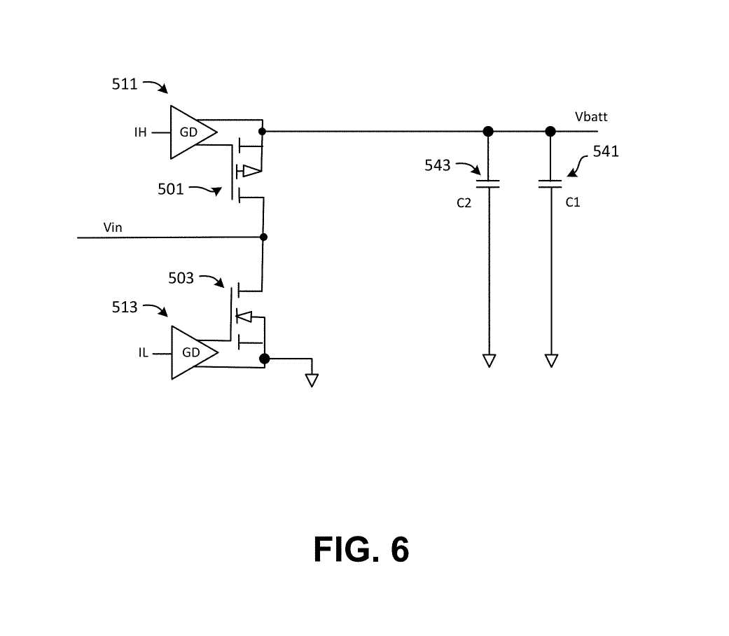

FIG. 5 is an example of an active or synchronous rectifier have a plurality of switches (e.g., that may be implemented as transistors as shown) that is operated as voltage doubler circuit rectifier when the coupled voltage is low (e.g., lower than a reference voltage) and in a second, variable impedance mode when the coupled voltage is high (e.g., at a voltage level higher than the reference voltage). The AC input voltage waveform Vin of the synchronous rectifier 500 of FIG. 5 is received at the front end or section 502 (e.g., or front set of switches) at the IN node between the switches 501 and 503. The switch 501 is connected between the first intermediate nodes CPP and IN, and has its gate controlled by the driver 511 with input IH. The switch 503 is connected between IN and the second intermediate node CPN, with its gate controlled by the driver 513 with input IL.

The back end (section 504 or back set of switches) of the rectifier 500 includes a number of additional switches connected in series between the output node VRECT and ground. Switch 521 has a gate connected to driver 531 with input HH, and is connected between VRECT and CPP. Switch 523 has its gate connected to driver 533 with input HM, and is connected between CPP (e.g., see a first internal node shown) and Vbatt (e.g, a first output node). Switch 525 has its gate connected to driver 535 with input LM, and is connected between Vbatt and CPN (e.g., see a second internal node shown). Switch 527, whose gate is connected to driver 537 with input LL, is connected between this CPN and ground. The capacitor C1 541 is also connected between the two intermediate nodes CPP and CPN in parallel with the two front section switches 501 and 503.

In the discussion here, the output of the rectifier 500 is taken at the node Vbatt (e.g., a DC output voltage), where the naming reflects an exemplary application of the circuit to the charging of a battery in a wireless charging system. A smoothing capacitor C2 543 is connected between the Vbatt output and ground.

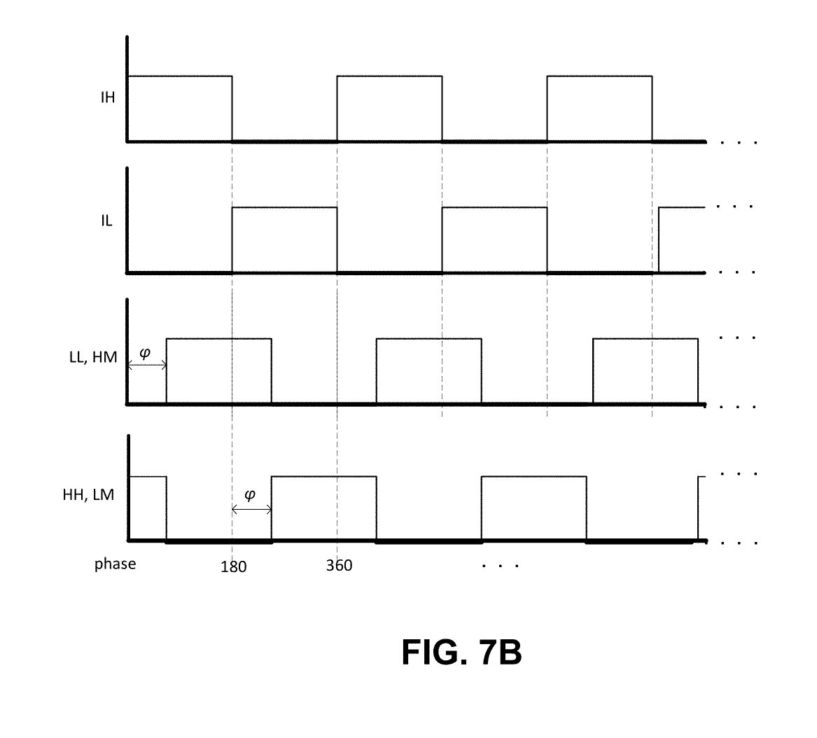

The switch 521 and its driver 531 allow the rectifier to act as a charge pump and are optional elements that can be included if the higher output at Vrect is wanted. Here, the node Vrect is connected to ground through capacitor C3 545 and resistance R5 547. These elements are shown in the dashed box to highlight that they are optional for applications that only use the Vbatt output. In the topology of FIG. 5, elements 527, 525, 523 and 525 form a charge pump when the back section is active, where Vrect is twice Vbatt when the rectification waveform of FIG. 7B is used. When there is no need for VRECT, the elements in the dashed box can be removed from the circuit with no impact on performance for the output at the Vbatt node.

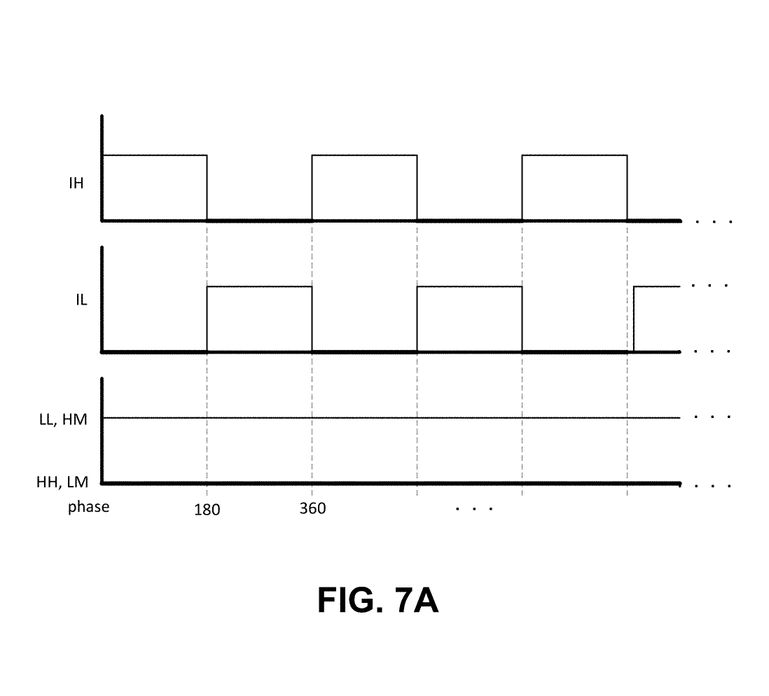

The control signals IH and IL in the front section 502 and HH (if 521 is included), HM, LM, and LL in the back section 504 are generated by the control block 571 (also referred to herein as a rectifier control circuit or controller circuit), based upon the Vin level. When the amplitude of the coupled voltage Vin is below a reference level Vref, the rectifier 500 can act as a voltage doubler rectifier (e.g., according to a first mode). The particular value used for Vref can be selected based upon the rectifiers application, the characteristic of the Vin, or some combination the these and other properties. In this low input voltage mode, the back section switches are supplied with fixed voltage levels so that switches 527 and 523 are held turned on and switches 525 and 521 (if present) are turned off, effectively reducing the rectifier 500 to the form shown in FIG. 6, with the voltage doubler rectification being done by the switches 501 and 503. The control block 571 includes the switching circuitry, such as represented by the first switch SW1 and second switch SW2, to change the control signals HH, LM and HM, LL between the two modes.

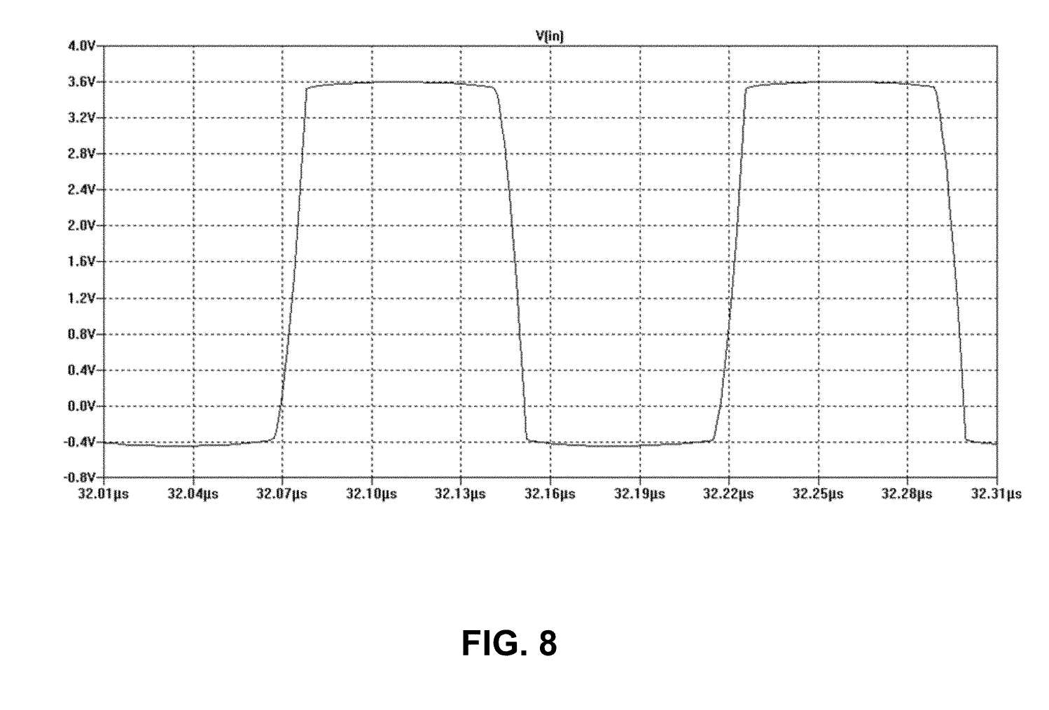

FIG. 7A illustrates the control waveforms in this mode of operation. The control signals IH and IL are non-over overlapping clock signals having the same fundamental frequency as Vin and with IH high when the Vin is positive. FIG. 7A shows IL and IH as having 50% duty cycles, although an intermediate period with both off can be introduced if desired. (In real applications, this is typically a dead time between the falling edge of one gate and the rising of the next.) In this mode, the back section switches are not clocked, with LL and HM held at high level, to keep switches 527 and 523 turned on, and HH and LM at a low level, to keep switches 525 and 521 off (while high and low levels have been used it is appreciated that other types of control waveforms may be provided to maintain switches 527 and 523 turned on or actuated while maintaining switches 525 and 521 off or unactuated). FIG. 8 shows the waveform at the IN pin when the rectifier is operating in the low input voltage mode with the rectifier acting as a voltage doubler.

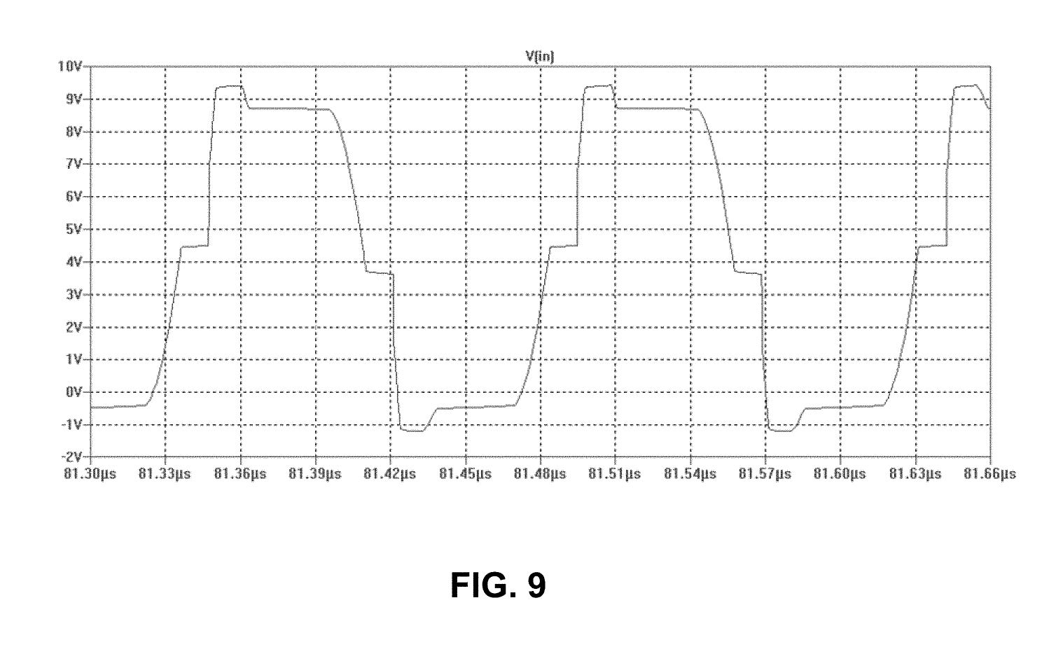

When the amplitude of coupled voltage Vin is higher, it is often desirable to have a battery voltage that is half (or less) of the peak to peak voltage (e.g., according to a second mode). FIG. 7B shows a set of control waveforms in this mode when the amplitude of Vin is greater than the reference level Vref. The front section receives the non-overlapping clock signals IL and IH as in the low input mode. The back section control signals are also clocked and of the same frequency as the input waveform Vin. In this example, LL and HM are operated in unison, as are HH and LM. The back section control signals are third and fourth non-overlapping clock signals respectively for LL, HM and HH, LM. The LL, HM signal can be in phase with IH or offset by a phase φ, as discussed more below. Similarly, the HH, LM can be in phase with IL or offset by a phase φ. FIG. 7B is again shows the case of a 50% duty cycle for both the third and fourth clock signal, which both use the same phase offset φ; but the arrangement can be generalized. FIG. 9 shows the waveform at the IN pin when the rectifier is operating in this mode.

In the high Vin mode, the front section 502 of the rectifier performs a synchronous rectification that is approximately in phase with the current on the Vin pin. The turn on of 501 and 503 would typically be done when the drain to source voltage is approximately 0 volts, for zero voltage switching (ZVS). ZVS typically leads to better efficiency, but does not have to be used.

In the high input mode, the back section 504 of the rectifier (521, 523, 525, 527) may run in phase with the front section 502, or with a time delay before or after the front section, as represented by the phase φ in FIG. 7B. The turn on of the back section of the rectifier can be done with ZVS for improved efficiency, although this is not required. The turn off of the back section is an adjustable time delay from the turn off of the first half and can be determined by the circuitry of control block 571 based on the Vin level. Reduction in this delay close to zero makes the input impedance of the rectifier approximately four times the impedance of the voltage doubler mode.

Changing the phase relationship can change the impedance transformation over a range of four times to zero times by shifting the relative phase φ of the two halves of the rectifier from 0 to 180 degrees apart. Under this arrangement, the impedance of rectifier is a decreasing (or monotonically non-increasing) function of the phase. In many implementations, much of this range may not be used due to non-ZVS switching and losses that can be quite high, especially as the two rectifier halves approach 180 degrees in phase difference. As such, however, in operation, the rectifier can alter/adjust the phase relationship to adjust the input impedance (e.g., to some target input impedance).

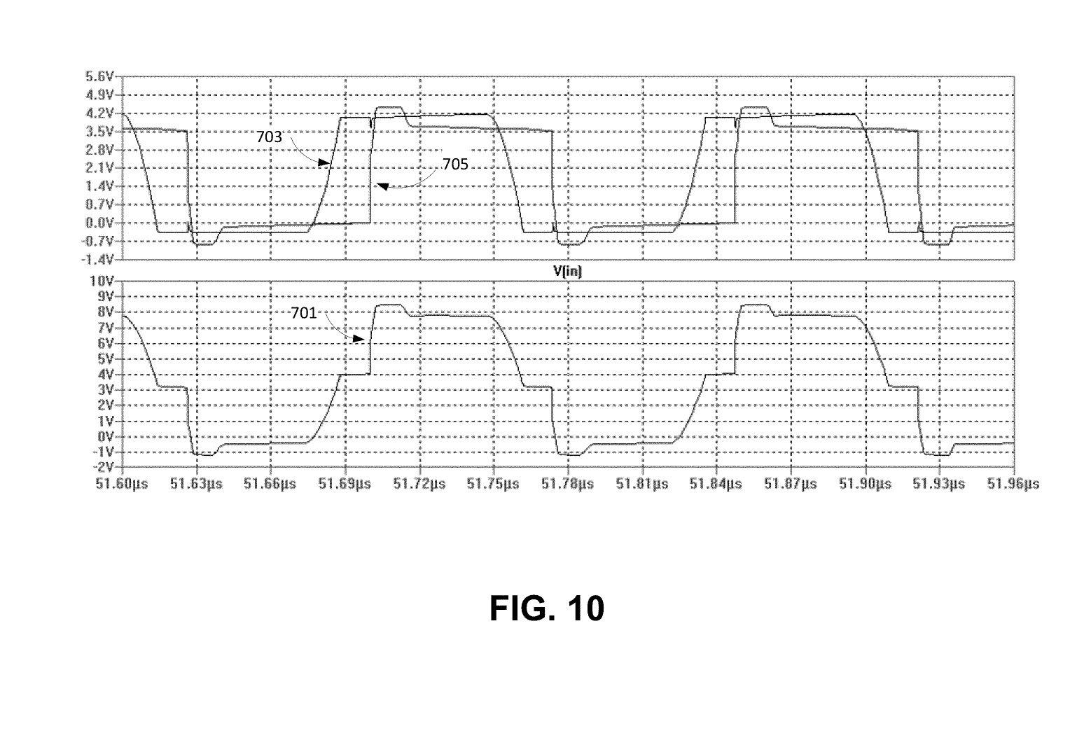

The simulation of FIG. 10 represents the level on the rectifier's input along with the waveforms within the two sections of the rectifier. The lower plot in FIG. 10 shows the waveform at the rectifier's input node (IN in FIG. 5) by the trace 701 when the two halves of the rectifier are running out of phase by approximately 45 degrees. The waveform at the front section of the rectifier is shown by the trace 703 and represents the voltage across switch 503 (FIG. 5) between the nodes IN and CPN. The waveform at the back section of the rectifier is shown by the trace 705 and represents the voltage on CPN. The two halves of the rectifier can be driven at 50% duty cycle, i.e., where an equal time is spent low and high. When this is done, the rectifier is balanced and generates no significant even harmonics. The phase difference between the two halves of the rectifier will have an effect on the odd harmonics the waveform.

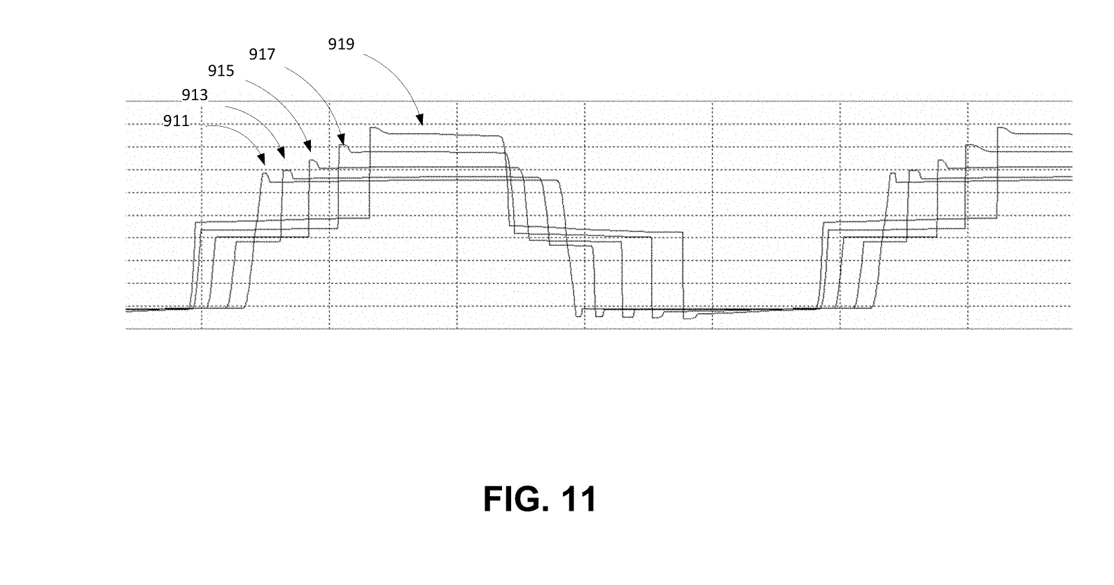

FIG. 11 shows the rectifier waveform at the input node IN as the phase is changed from 1 to 120 degrees. Table 1 lists the correspondence between the phase difference and the reference numbers in FIG. 11. Table 1 also lists the impedance for simulated rectifier vs phase angle with a DC load impedance of 10 ohms, illustrating the impact of the phase offset on the input impedance, where the input impedance transformation of a rectifier is proportional to the voltage transformation squared.

TABLE 1
Impedance for simulated rectifier vs phase angle

| | | Reference |
|---|---|---|
| Phase Difference φ | | number in |
| (in degrees) | Impedance | FIG. 11 |
| 1 | 8.50-0.5j | 911 |
| 30 | 7.40-2.1j | 913 |
| 60 | 5.00-2.9j | 915 |
| 90 | 2.91-2.1j | 917 |
| 120 | 1.45-1.6j | 919 |

The topology described also may be applied to modulating the harmonics by changing the timing of the rectifier circuits for use in out-of-band reverse signaling, where the wireless receive circuit can signal to the receive circuit (that is, the field 105 of FIG. 1 is again used, but the direction is from the receive coupler 118 to the transmit coupler 114). The input impedance can also be changed at the fundamental frequency in a controlled manner, allowing for in-band reverse link communication. For example, changing the duty cycle of either of the sections of the rectifier will increase the second harmonic and other even harmonics. Where the fundamental, second and fourth harmonics fall on ISM bands and face less regulatory limits (as is the case for the 6.78 MHz ISM frequency band), these would be often be useful frequencies on which to carry data. Since the input impedance is a function of the phase difference, modulation of the fundamental frequency by changing the relative phase can also be used for reverse signaling (e.g., causing impedance changes according to a sequence to form a message detectable at the transmitter). Changing the phase of the two rectifier parts with respect to each other alters the odd harmonics generated by the rectifier. There is a null point for each odd harmonic located at a phase of (180/harmonic number) degrees. For example, the third harmonic disappears when the sections are 60 degrees out of phase.

Referring back to FIG. 4, the processor signaling controller 416 of the receive circuit may determine to send a status indication back through the receive coupler 404. For example, when the load 450 is a battery that is being charged, the reverse signaling could be used to let the transmit circuit know the charge level of the battery. By use of the different available in and out-of-band channels, similar techniques allow for the reverse signaling of various sorts of information that can then be used by the transmit circuit to alter wireless field.

While FIG. 5 shows a particular configuration of switching between modes in a dual mode rectifier, it should be appreciated that the principles described herein may be applied to a variety of rectifier topologies with at least two modes such as a voltage doubler rectifier circuit mode and an alternate mode as described above. As such in accordance with an aspect of an exemplary embodiment, a rectification apparatus is provided that includes including a rectifier circuit comprising a plurality of switches and that is configured to output a DC output voltage based on an AC input voltage waveform. A controller circuit is then configured to drive the plurality of switches to cause the rectifier circuit to be configured in a first mode (e.g., for example a voltage doubler circuit mode) in response to a voltage level of the input voltage waveform being below a reference voltage. The controller circuit can also drive the plurality of switches to cause the rectifier circuit to be configured in a second mode, different than the first mode, in response to the voltage level of the input voltage waveform being above the reference voltage. As such, the apparatus can switch between modes to accommodate wider input voltage variations while maintaining the output voltage within acceptable limits and for various other purposes as described above. The reference voltage may be selected based on the particular application (e.g., for a wireless charging application for charging a portable electronic device, one particular example the reference voltage for determining when to switch could be on the order of between 8-16 volts).

In accordance, a method of providing a DC output voltage from an AC input voltage waveform is contemplated including rectifying the AC input voltage waveform to output the DC output voltage via a rectifier circuit comprising a plurality of switches. The method further includes altering one or more control signals of the plurality of switches to cause the rectifier circuit to be configured in a first mode (e.g., as a voltage doubler circuit) in response to a voltage level of the input voltage waveform being below a reference voltage. The method further includes altering the one or more control signals of the plurality of switches to cause the rectifier circuit to be configured in a second mode, different than the first mode, in response to the voltage level of the input voltage waveform being above the reference voltage.

Certain aspects herein therefore allow for rectifier implementations that may allow for handling a larger range of induced voltages on a receive coupler in a wireless power receiver. This may further allow for designs for receivers that may work with a variety of different transmitter designs. For example, for reducing cost and complexity, certain transmitter designs may have less magnetic field regulation capabilities and may experience wide ranges of currents through the resonator which then leads to a wider range of induced voltages on the receiver. Certain aspects of the embodiments described above and below may allow for handling a wider input voltage range.

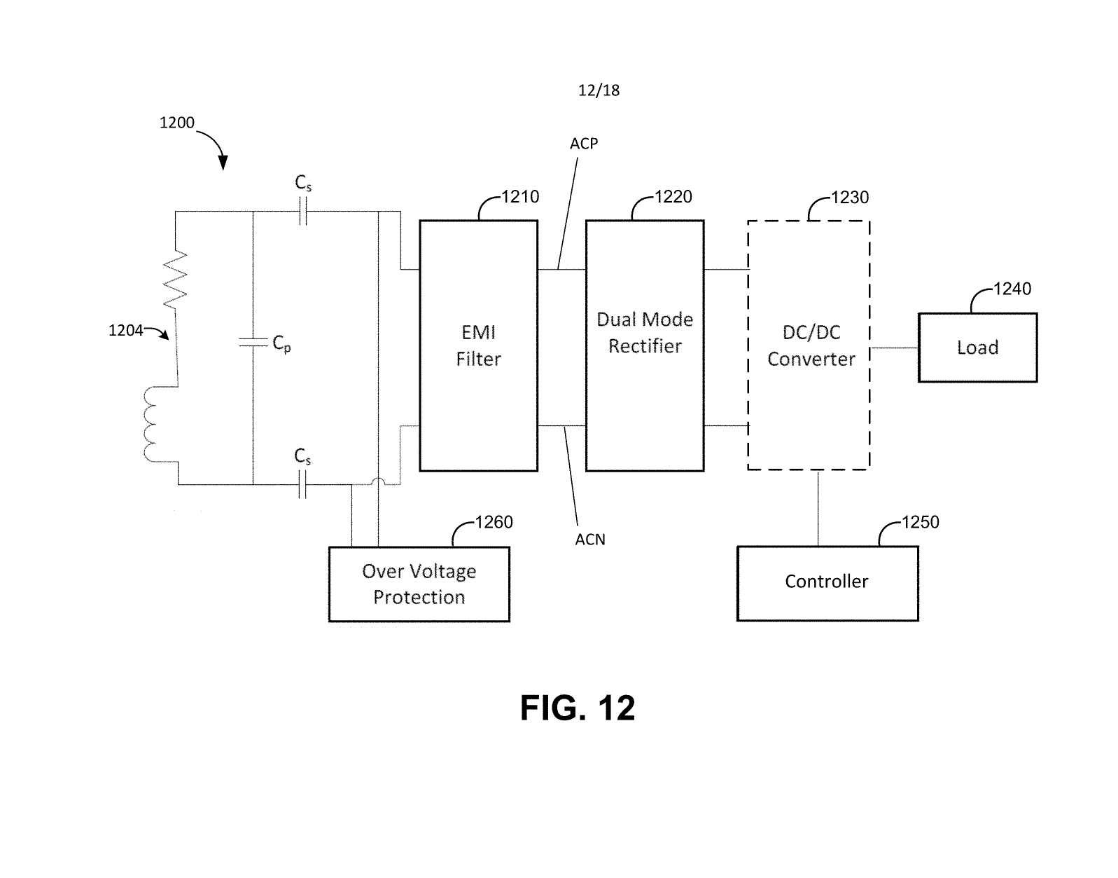

FIG. 12 is a functional block diagram of a wireless power receiver 1200 that includes similar components as described to FIG. 4 but shows a differential implementation. The receiver 1200 includes a receive coupler circuit 1204 that includes an inductor (corresponding to a receive coil/coupler) and a capacitive network to create a resonant circuit as described above. The capacitive network may also serve to be configured as part of a voltage doubler based on operation of the rectifier as further described below. The receiver 1200 further includes an EMI filter 1210 electrically connected between the receive coupler circuit 1204 and a dual mode rectifier circuit 1220. The receiver 1200 further optionally includes a DC/DC converter 1230 which may convert DC output by the dual mode rectifier circuit 1220 to a level more appropriate for a load 1240. However, in some implementations the operation of the dual mode rectifier circuit 1220 may allow for removing certain components, using less expensive or less lossy components, or eliminating the need for the DC/DC converter 1230. The output of the DC/DC converter 1230 is provided to a load 1240 (e.g., battery for charging or powering other circuitry). The receiver 1200 further includes a controller 1250 configured to control one or more operations of the receiver components similarly configured and described with respect to the controller 416 FIG. 4. An over voltage protection circuit 1260 is further provided.

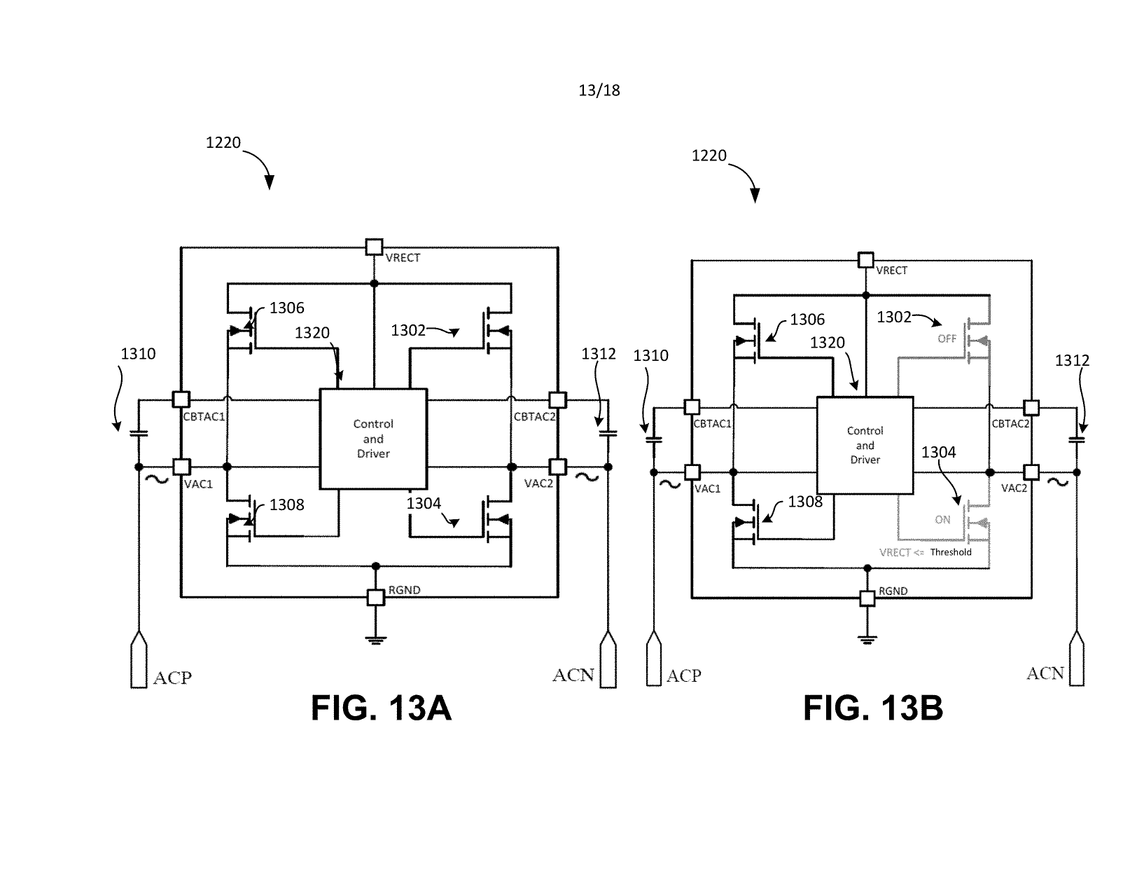

FIGS. 13A and 13B are schematic diagrams of a differential/single ended dual mode rectifier circuit 1220 of FIG. 12 in accordance with an embodiment. The dual mode rectifier circuit 1220 includes a plurality of switches including a first switch 1302, a second switch 1304, a third switch 1306, and a fourth switch 1308. A control and driver circuit 1320 may be configured to output control signals that drive/control the switches 1302, 1304, 1306, and 1308 to cause rectification in at least two different modes. The dual mode rectifier circuit 1220 further shows a first capacitor 1310 electrically connected to a first input and a second capacitor 1312 connected to a second input that may be provided as part of the ability to drive the switches.

The control and driver circuit 1320 can drive the switches 1302, 1304, 1306, and 1308 with different waveforms adjust the output voltage and adjust the input impedance of the dual mode rectifier circuit 1220 based on the operating conditions. For example, as shown, the control and driver circuit 1320 is configured to adjust the control signals to switch between a voltage doubler rectifier and a full bridge rectifier with four switches (although one in the art may appreciate how the circuit may be adapted to include fewer or more switches).

More particularly, FIG. 13A shows the dual mode rectifier 1220 in a full bridge rectifier mode. In this case, the control signals may be synchronous (e.g., having substantially equal frequency and possibly phase) with the two input waveforms received at ACP and ACN to output a substantially DC output voltage at Vrect. In a normal operating condition, the DC output voltage is substantially the same or close to the peak voltage of the input waveforms (e.g., less any rectifier losses, etc.). FIG. 13B, shows the dual mode rectifier 1220 switched to be in a voltage doubler rectifier mode. In this case the control signals from the control and driver circuit 1320 may be adapted such that the first switch 1302 is maintained off while the mode is enabled while the second switch 1304 is maintained on while the mode is enabled. This doubler mode may enabled the rectifier output voltage is less than or equal to a threshold voltage. The third switch 1306 and fourth switch 1308 may then be controlled synchronous with the input waveform to provide a voltage output at Vrect that is substantially double a level of the peak of the input waveforms.

Switching between modes allows for operating at higher induced voltages at the receive coupler circuit 1204 (FIG. 12) while maintain a constrained acceptable output voltage range which allows lower losses and therefore higher output power to the load. Furthermore, extending the range of possible induced voltages that can be efficiently handled can lead to more consistent power delivery characteristics under variations in magnetic field coupling operating conditions. Switching between the modes of the dual mode rectifier circuit 1220 may be controlled using several methods similar to those described above. In one aspect, the thresholds may be based on sensing the rectifier DC voltage and determining whether the rectifier DC voltage is above or below a threshold.

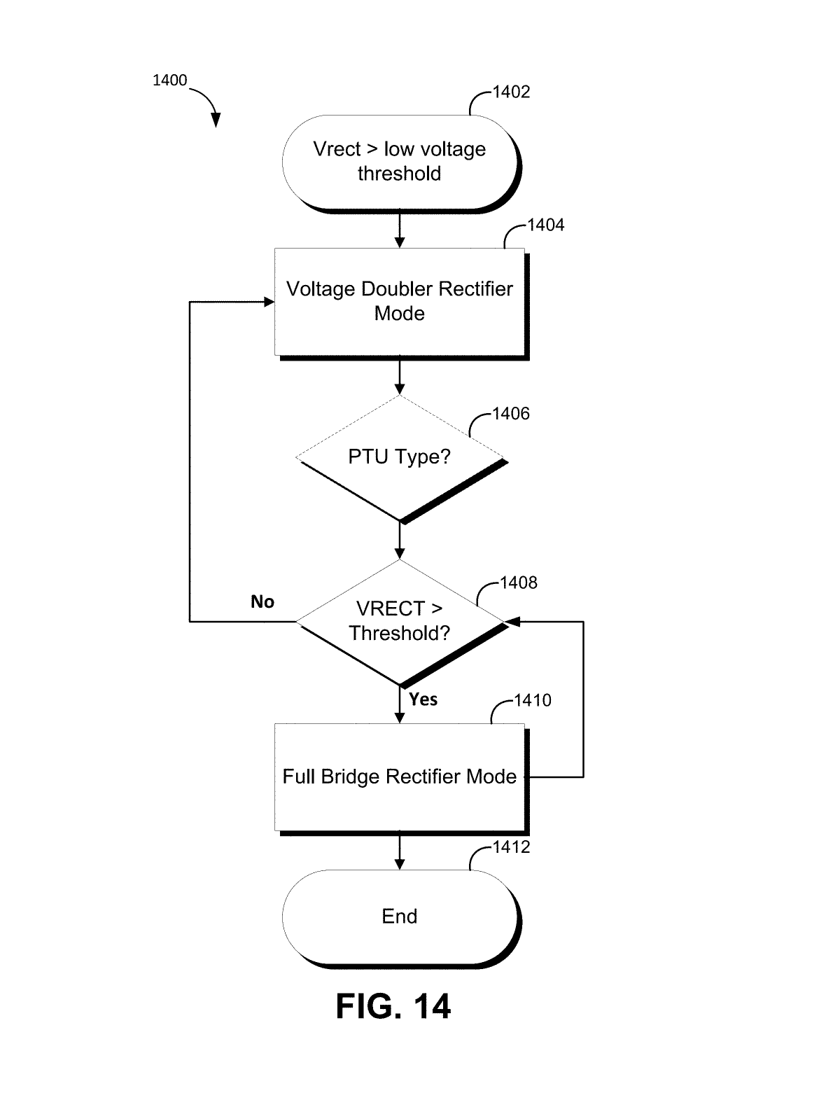

FIG. 14 is a diagram of a flowchart of a method 1400 for switching modes of a dual mode rectifier circuit 1220 in accordance with an embodiment. The method 1400 begin at block 1402 where rectification may occur DC voltage Vrect is greater than some sort of low voltage threshold (e.g., under which may correspond to some low voltage threshold condition). In this case, the dual mode rectifier circuit 1220 may be in a voltage doubler rectifier mode as depicted in block 1404. At block 1406 the receiver 1200 optionally determines the type of transmitter that the receiver 1200 is currently receiving power from. The receiver 1200 can identify the type of the transmitter based on a variety of methods such as out of band messages exchanged with the transmitter or by way of in-band/reverse in-band signaling schemes. If the transmitter is of a type that has one or more characteristics indicative that a wider range of potential receiver voltages may occur, the receiver determines whether Vrect is greater than a threshold reference voltage at block 1408. If Vrect remains under the threshold reference voltage then the dual mode rectifier circuit 1220 remains in the voltage doubler rectification mode as shown by the arrow to block 1404. Note that if block 1406 is not present, the receiver 1200 is maintained in the voltage doubler rectifier mode while the output voltage is under the threshold voltage. Otherwise, if Vrect is above the reference voltage, then the dual mode rectifier circuit 1220 is adjusted to operate according to the full bridge rectifier mode 1410 as shown in block 1410. If Vrect later falls below the threshold, then then receiver 1402 switches back to the voltage doubler rectifier mode. The method 1400 ends at block 1412. While the method 1400 has been described with reference to FIGS. 12 and 13, it is appreciated that the method 1400 may be similarly applied to the rectifier circuit 500 shown in FIG. 5 for switching between the two modes as described above (e.g., either based on Vrect or based on comparing the input waveform to one or more thresholds as described above).

In addition to managing the output voltage based on the input voltage waveform, as described above, the switches of the synchronous rectifiers may be operated in rectification modes and ways to allow reverse link signaling/messaging to a transmitter. More particularly, by operating the rectifier circuits described above in a way that adjusts the rectifier input impedance, the reflected changes in the impedance by the receive coupler are detectable at the transmitter and can be interpreted as messages based on detecting the sequence of impedance changes.

Even more particularly, switching the dual mode rectifier circuit 1220 of FIGS. 13A and 13B between a voltage doubler rectifier mode and a full-bridge rectifier mode that create a detectable impedance/power variation at the transmitter. The dual mode rectifier circuit 1220 may provide an impedance transformation with a resistive load and may create a transient impedance shift during mode switching when a constant power load is present. These mechanisms therefore may then be used for implementing a signaling mechanism from the receiver to the transmitter as will be further described below. At least one benefit of using the rectifier to accomplish the impedance modulation is that the components can be fully integrated and may already be desired/present in the receiver design (for meeting receiver operating requirements). Several in-band signaling scenarios are described more specifically below. While several signaling mechanisms are described with reference to the dual mode rectifier circuit 1220 and corresponding voltage doubler and full bridge modes shown in FIGS. 13A and 13B, it is appreciated that these mechanisms may be extended to other dual mode rectifier configurations such as, but not limited to, the rectifier circuit 500 described above with reference to FIG. 5.

As a first example, mode switching of the dual mode rectifier circuit 1220 may be used to signal to the transmitter when it is trying to accomplish a boot-up operation, for example from a dead battery. For example, the receiver 1200 may be booting up after being powered by the transmitter and the receiver 1200 may have a protocol to signal to the transmitter in order to identify itself, or request an extension of a low power “beacon” signal used for powering the receiver while it identifies itself to trigger a higher transmitter power level. In accordance with an aspect a resistive load (e.g., fixed load) is electrically coupled at the output of the dual mode rectifier circuit 1220 (e.g., after Vrect). The control and drive circuit 1320 (FIGS. 13A and 13B) switches between modes on the dual mode rectifier circuit 1220 (e.g., between the voltage doubler rectifier and the full bridge rectifier) according to a pattern or sequence that corresponds to modulation of a characteristic of the power transfer field due to the impedance changes to convey information detectable by the transmitter. The effect of toggling between the modes results in switching effective receiver impedance (as seen from the transmitter) that is measured and interpreted as a message. By adjusting the frequency and duty cycle of the toggling between rectifier modes (and corresponding de-modulation at the transmitter), data can be transferred from the receiver to the transmitter.

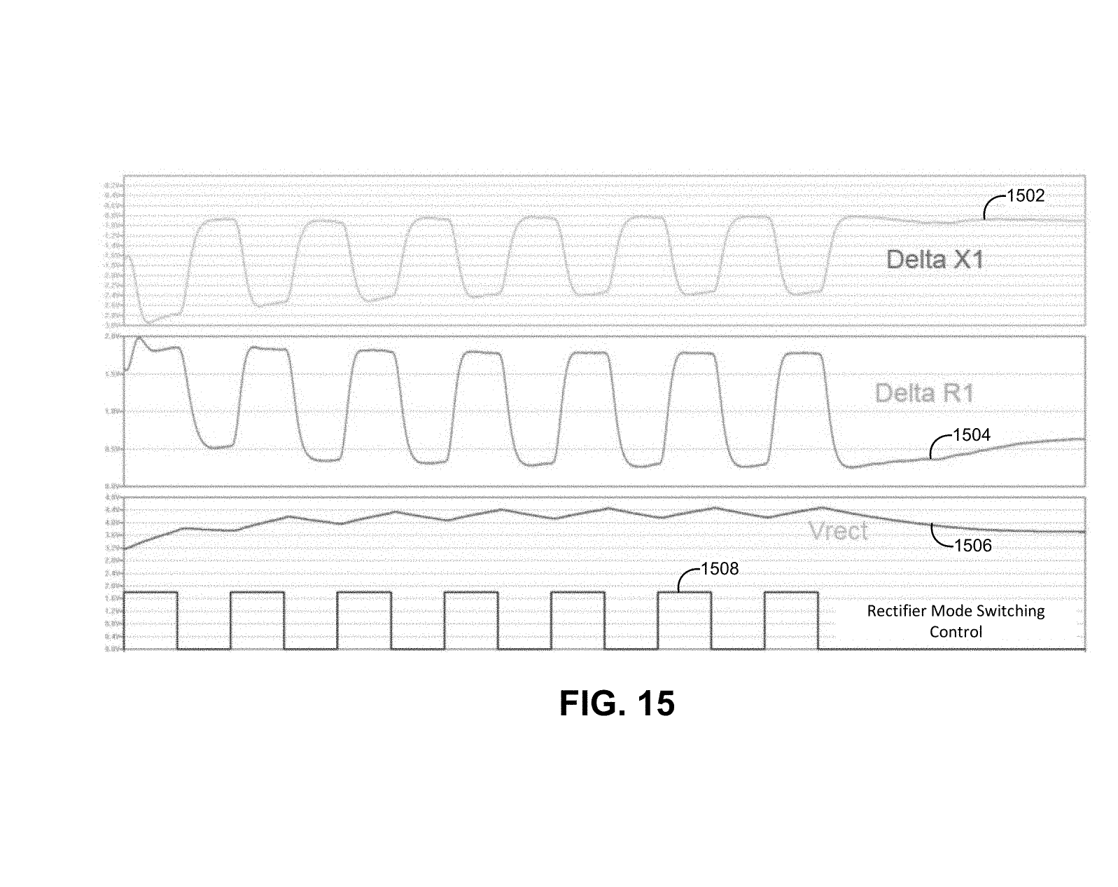

FIG. 15 is a diagram showing exemplary waveforms in accordance with a rectifier mode switching in-band signaling technique showing impedance shifts which can be measured on the transmitter in accordance with an exemplary embodiment. FIG. 15 shows a waveform 1508 that may correspond to toggling the dual mode rectifier circuit 1220 between two modes that may occur during a boot-up period or otherwise when the receiver 1200 is first placed in a wireless charging field. As shown the output voltage Vrect waveform 1506 is substantially stable even while switching such that a substantially uniform level of power is still output. A reactance waveform 1502 and resistive waveform 1504 at the transmitter is shown to indicate that the transmitter may measure and analyze either the real or imaginary component (or both) of the impedance to see the changes and interpret the message. In response to seeing the message, the transmitter may increase the power or extend a low power signal to allow the receiver to start charging.

Another scenario in which in-band signaling by toggling between rectifier modes may be beneficial is for indicating to the transmitter an onset or trigger of an over voltage condition. In accordance, the receiver 1200 may cause the dual mode rectifier circuit 1220 to switch between the two rectifier modes that may done in a way to be detected by the transmitter as a signal that the receiver 1200 is nearing or at an over voltage condition. When signaled before the over voltage condition occurs, the transmitter may regulate its current or other power transfer characteristics to prevent the receiver 1200 from even reaching the over voltage condition threshold. If the over voltage condition threshold is reached, the receiver 1200 may clamp the dual mode rectifier circuit 1220 in the full-bridge mode that may reduce the rectifier voltage as much as possible.

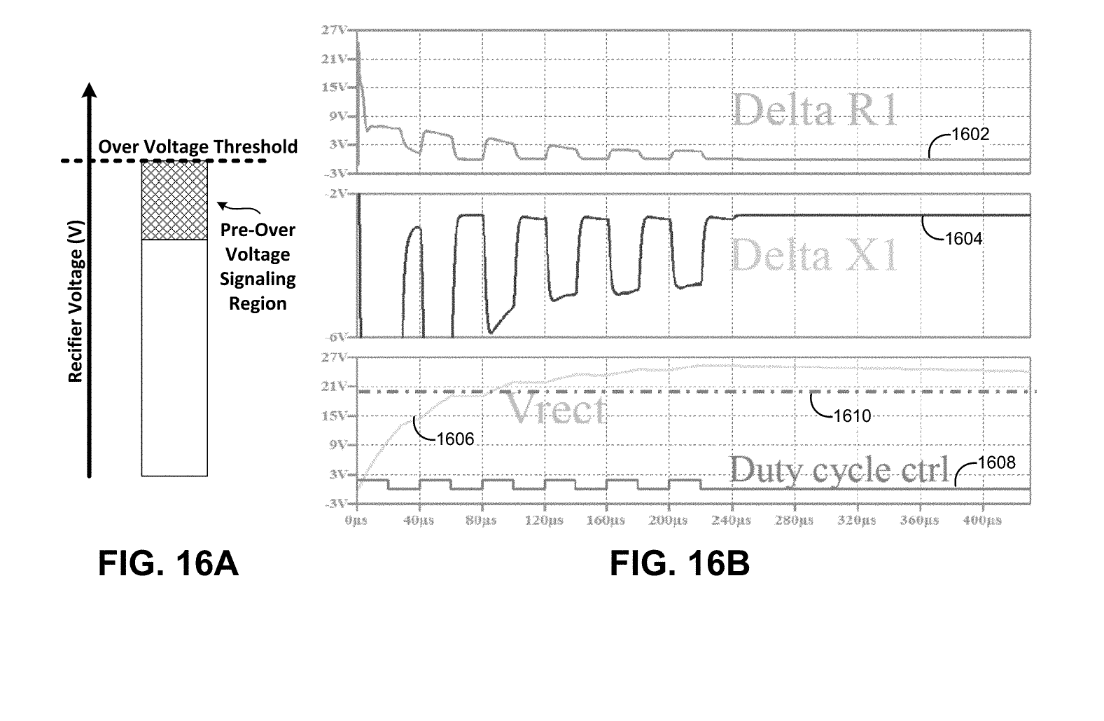

FIG. 16A is a diagram outlining a rectifier mode switching signaling operation relative to an over voltage threshold. In this case, before an over voltage threshold may trigger, the rectifier mode switching as described above is initiated to signal to the transmitter of a potential over voltage condition as shown in the shaded region.

FIG. 16B is a another diagram showing exemplary waveforms in accordance with a rectifier mode switching in-band signaling technique showing impedance shifts which can be measured on the transmitter in accordance with an exemplary embodiment. As shown waveform 1608 may represent a control signal for toggling between the two rectifier modes. The line 1610 waveform may represent a “pre-warning” threshold for starting to signal to the transmitter that an over voltage condition may be approaching. As shown, the output voltage waveform 1606 may reach the threshold to trigger the signaling. Impedance waveforms real 1602 and imaginary 1604 (i.e., resistive and reactive) at the transmitter are shown that can be detected by the transmitter as an indication an over voltage condition is approaching. Adjusting the frequency and duty cycle of the switching between rectifier modes (and corresponding demodulation at the transmitter) allows signaling to the transmitter corresponding to the over voltage condition approaching. The switching between rectifier modes additionally still allows for measurement of the rectifier voltage and detecting the over voltage condition. This technique may allow for faster signaling of such a condition to the transmitter (e.g., faster potentially compared to an out-of-band message sent via something like Bluetooth). In addition be signaling before the threshold is reached, the reliance on aspects of over voltage protection circuitry may be reduced or even certain types of over voltage protection circuitry may be eliminated.

In a situation where the over voltage threshold is triggered, in an alternative embodiment, the switching between rectifier modes for communication to the transmitter of the over voltage event can be triggered for some fixed period of time when the output voltage is detected as at or above the over voltage threshold. After this period of time, the receiver 1200 may clamp the dual mode rectifier circuit 1220 to a full bridge mode to limit the rectifier voltage.

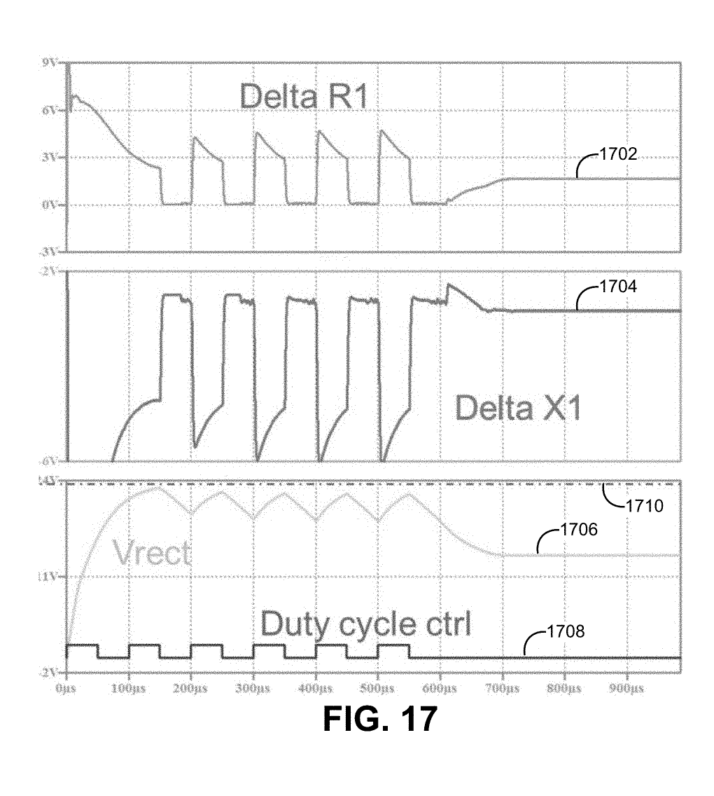

FIG. 17 is a diagram showing exemplary waveforms in accordance with a rectifier mode switching in-band signaling technique showing impedance shifts which can be measured on the transmitter in accordance with an exemplary embodiment. The waveform 1708 shows a control waveform for toggling between the rectifier modes. Once Vrect is above the over voltage threshold, the toggling can begin for some period of time which causes detectable impedance changes at the transmitter as shown by the impedance waveforms 1702 and 1704. Waveform 1710 shows the over voltage threshold as one example. After some period of time, the receiver 1200 clamps to the full bridge mode to reduce the output voltage at the rectifier. Note that the techniques described with reference to FIGS. 16A and 16B and 17 may be combined in some cases such that there is both signaling before the over voltage threshold is hit and after the threshold is hit.

Another scenario in which in-band signaling by toggling between rectifier modes may be provided is when the receiver is delivering power to a constant power load (e.g., battery charging). Stated another, the signaling is done for various purposes during periods of normal power transfer operation where there is a constant power output. Switching between the rectifier modes creates a detectable impedance change in the transmitter while not considerably affecting the output voltage of the rectifier or power delivered. This is an example of a transient impedance shift caused due to the switching between the modes of the dual mode rectifier circuit 1220. By adjusting the frequency and duty cycle of the rectifier mode switching, data messages may be transmitted from the receiver 1200 to the transmitter.

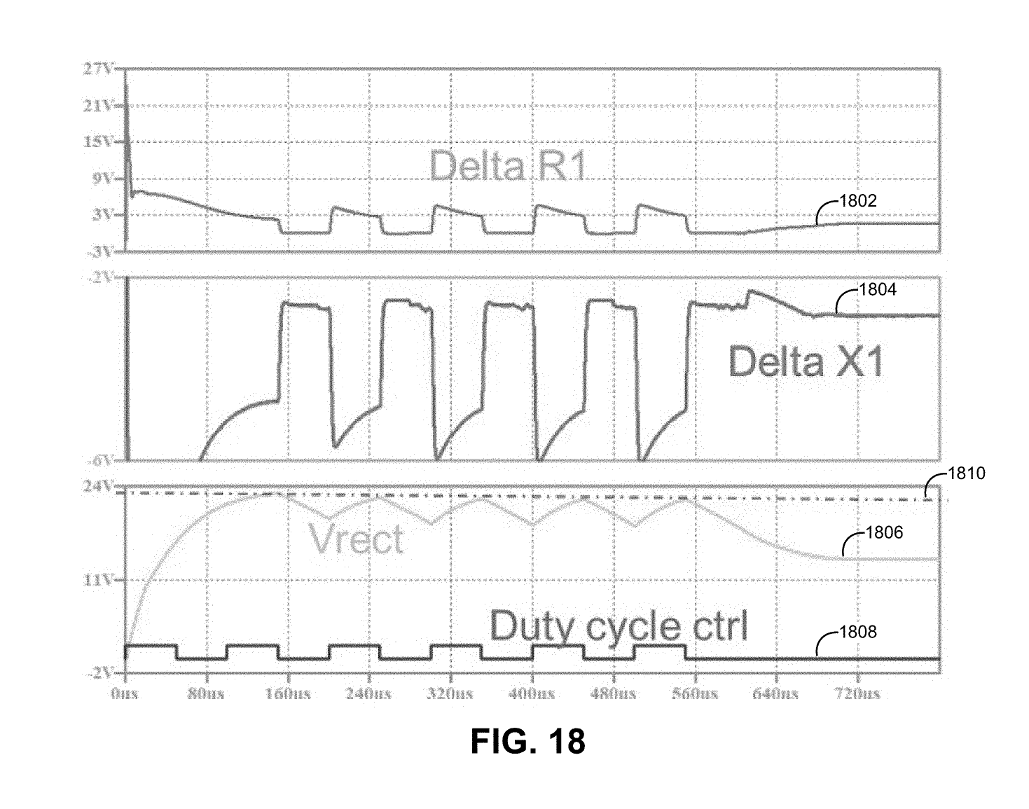

FIG. 18 is a diagram showing exemplary waveforms in accordance with a rectifier mode switching in-band signaling technique showing impedance shifts which can be measured on the transmitter in accordance with an exemplary embodiment. Similar to those described above, a control waveform 1808 is provided to toggle between rectifier modes. This does cause toggling of the output voltage Vrect as shown by the output voltage waveform 1806 but the variation is somewhat small and can still provide a sufficiently constant output voltage within a small range as shown. Impedance waveforms 1802 and 1804 at the transmitter show that the transmitter may be able to detect such changes in order to detect the signaling. Waveform 1810 shows an over voltage threshold.

The various operations of methods performed by the apparatus or system described above may be performed by any suitable means capable of performing the operations, such as various hardware and/or software component(s), circuits, and/or module(s). Generally, any operations or components illustrated in the Figures may be performed or replaced by corresponding functional means capable of performing the operations of the illustrated components.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such embodiment decisions may not be interpreted as causing a departure from the scope of the embodiments presented here.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular embodiment. Thus, the various aspects described here may be embodied or carried out in a manner that achieves or optimizes one advantage or group of advantages as taught herein without necessarily achieving other advantages as may be taught or suggested herein.

Components, functional or otherwise, shown in the figures and/or discussed herein as being electrically connected or communicating with each other are communicatively coupled. That is, they may be directly or indirectly connected to enable communication or other transfer of signals between them.

A description that an item, such as an embodiment, is exemplary is an indication that the item being described is an example. The use of the term “exemplary” does not necessarily indicate that the item being described is better than or preferred over other items, e.g., other embodiments.

Various modifications of the above described embodiments will be readily apparent, and the generic principles defined herein may be applied to other embodiments without departing from the spirit or scope of the disclosure. Thus, the disclosure is not limited to the implementations shown herein but is to be accorded the widest scope consistent with the principles and novel features disclosed herein.

What is claimed is:

1. An apparatus for wirelessly receiving power and powering or charging a load, the apparatus comprising:
a receive coupler configured to generate an alternating current (AC) input voltage waveform in response to an externally generated magnetic field;
a rectifier circuit electrically connected to the receive coupler, the rectifier circuit comprising:
a first switch electrically connected between a first internal node and an input node electrically connected to the receive coupler to receive the input voltage waveform;
a second switch electrically connected between the input node and a second internal node;
a third switch electrically connected between the first internal node and a first output node;
a fourth switch electrically connected between the first output node and the second internal node;
a fifth switch electrically connected between the second internal node and ground;
a first capacitor electrically connected between the first internal node and the second internal node; and
a second capacitor electrically connected between the first output node and the load.

2. The apparatus of claim 1, wherein the apparatus further comprises a rectifier control circuit electrically connected to the first switch, the second switch, the third switch, and the fourth switch and configured to output:
a first control signal to control the first switch;
a second control signal to control the second switch, wherein the first control signal and the second control signal are non-overlapping and both have a frequency substantially equal to a frequency of the input voltage waveform;
a third control signal to control the third switch and the fifth switch; and
a fourth control signal to control the fourth switch.

3. The apparatus of claim 2, wherein the rectifier control circuit is configured to alter a phase between the third control signal and the first control signal.

4. The apparatus of claim 3, wherein the rectifier control circuit is configured to alter the phase to adjust an input impedance of the rectifier circuit to a target input impedance.

5. The apparatus of claim 3, wherein the rectifier control circuit is configured to alter the phase according to a sequence corresponding to a message detectable based on changes in impedance reflected by the receive coupler.

6. The apparatus of claim 2, wherein:
the rectifier control circuit is configured to cause the third control signal to be maintained at a high level according to a first mode and configured to cause the third control signal to have a frequency substantially equal to a frequency of the input voltage waveform according to a second mode; and
the rectifier control circuit is further configured to cause the fourth control signal to be maintained at a low level according to the first mode and configured to cause the fourth control signal to have a frequency substantially equal to a frequency of the input voltage waveform according to the second mode, wherein the third control signal and the fourth control signal are non-overlapping according to the second mode.

7. The apparatus of claim 6, wherein the rectifier control circuit is configured to operate according to the first mode in response to an amplitude of the input voltage waveform being less than a reference voltage level, and wherein the rectifier control circuit is configured to operate according to the second mode in response to an amplitude of the input voltage waveform being greater than the reference voltage level.

8. The apparatus of claim 6, wherein the first mode corresponds to a voltage doubler circuit and wherein the second mode corresponds to a mode wherein a DC output voltage at the first output node is substantially half or less than a peak to peak voltage level of the input voltage waveform.

9. The apparatus of claim 1, wherein the rectifier circuit further comprises a sixth switch electrically connected between the first internal node and a second output node.

10. A rectification apparatus, the apparatus comprising:
a rectifier circuit comprising a plurality of switches, the rectifier circuit configured to output a DC output voltage based on an AC input voltage waveform; and
a controller circuit electrically connected to the rectifier circuit and configured to:
drive the plurality of switches to cause the rectifier circuit to be configured in a first mode as a voltage doubler circuit in response to a voltage level of the input voltage waveform being below a reference voltage; and
drive the plurality of switches to cause the rectifier circuit to be configured in a second mode, different than the first mode, in response to the voltage level of the input voltage waveform being above the reference voltage.

11. The rectification apparatus of claim 10, wherein in the second mode the DC output voltage has a level that is at least one of substantially equal to a peak of the input voltage waveform or half or less than the peak to peak level of the input voltage waveform.

12. The rectification apparatus of claim 10, wherein the plurality of switches comprises a front set of switches electrically connected to receive the input voltage waveform and a back set of switches electrically connected to the front set of switches, the back set of switches configured to provide the DC output voltage.

13. The rectification apparatus of claim 12, wherein the front set of switches comprises a first switch electrically connected between a first internal node and an input node that receives the input voltage waveform and a second switch electrically connected between the input node and a second internal node, wherein the back set of switches comprises a third switch electrically connected between the first internal node and a first output node, a fourth switch electrically connected between the first output node and the second internal node, and a fifth switch electrically connected between the second internal node and ground, and wherein the rectifier circuit further comprises a first capacitor electrically connected between the first internal node and the second internal node and a second capacitor electrically connected between the first output node and a load.

14. The rectification apparatus of claim 12, wherein the controller circuit is configured to output a first set of control signals that control the front set of switches and output a second set of control signals that control the back set of switches, wherein the first set of control signals have a frequency substantially equal to the frequency of the input voltage waveform and wherein the first set of control signals are in phase with the input voltage waveform.

15. The rectification apparatus of claim 14, wherein the controller circuit is configured to cause the rectifier circuit to be in one of the first mode or the second mode by adjusting the second set of control signals.

16. The rectification apparatus of claim 14, wherein the controller circuit is configured to alter a phase between the second set of control signals and the first set of control signals.

17. The rectification apparatus of claim 16, wherein the controller circuit is configured to alter the phase to adjust an input impedance of the rectifier circuit to a target input impedance.

18. The rectification apparatus of claim 16, wherein the controller circuit is configured to alter the phase according to a sequence corresponding to a message.

19. The rectification apparatus of claim 10, further comprising a receive coupler electrically connected to the rectifier circuit and configured to wirelessly couple power via an externally generated magnetic field and generate the input voltage waveform.

20. A rectification circuit, comprising:
a control signal circuit configured to output a plurality of control signals, including a first control signal of a first clock signal, a second control signal of a second clock signal, wherein the first clock signal and the second clock signal are non-overlapping and both have a frequency substantially equal to a frequency of an input waveform, the control circuit further configured to output a third control signal and a fourth control signal;
the control signal circuit configured to cause the third control signal to be maintained at a non-clocked high level in response to an input waveform amplitude being less than a reference level and configured to cause the third control signal to be a third clock signal having a frequency substantially equal to a frequency of the input waveform in response to the input waveform amplitude being greater than the reference level;
the control signal circuit further configured to cause the fourth control signal to be maintained at a non-clocked low level in response to the input waveform amplitude being less than the reference level and configured to cause the fourth control signal to be a fourth clock signal having a frequency substantially equal to a frequency of the input waveform, wherein the third clock signal and the fourth clock signal are non-overlapping; and
a synchronous rectifier electrically connected to receive the input waveform and generate therefrom a first output voltage, including:
a) a front set of switches electrically connected to receive the input waveform, the first control signal, and the second control signal; and
b) a back set of switches electrically connected to the front set of switches, the third control signal and the fourth control signal, and configured to output the first output voltage from a first output node.

21. The rectification circuit of claim 20, wherein the control signal circuit is configured to alter a phase of the third clock signal and the fourth clock signal relative to a phase of the first clock signal.

22. The rectification circuit of claim 21, wherein the amount the phase is altered is based on the input waveform amplitude such that the phase of the first clock signal is a decreasing function of the amplitude of the input waveform.

23. The rectification circuit of claim 21, wherein the phase is altered to adjust an input impedance of the synchronous rectifier.

24. The rectification circuit of claim 20, wherein:
the front set of switches of the synchronous rectifier includes a first switch connected between a first internal node and an input node connected to receive the input waveform, and a second switch connected between the input node and a second internal node, wherein the first switch is connected to be controlled by the first control signal and the second switch is connected to be controlled by the second control signal; and
the back set of switches of the synchronous rectifier includes a third switch connected between the first internal node and the first output node, a fourth switch connected between the first output node and the second internal node, and a fifth switch connected between the second internal node and ground, wherein the third switch and the fifth switch are connected to be controlled by the third control signal and the fourth switch is connected to be controlled by the fourth control signal, and wherein the synchronous rectifier further includes a capacitor connected between the first internal node and the second internal node.

25. The rectification circuit of claim 24, wherein the back set of switches further includes a sixth switch connected between the first internal node and a second output node, wherein the sixth switch is connected to be controlled by the fourth control signal.

26. The rectification circuit of claim 20, wherein the rectification circuit is part of a receive circuit for wireless power transfer and the input waveform is received from a receive coupler of the receive circuit.

27. The rectification circuit of claim 26, wherein the receive circuit further includes a signaling controller connected to the rectification circuit, wherein the control signal circuit varies the plurality of control signals in response to the signaling controller to reverse signal through the receive coupler.

28. A method of providing a DC output voltage from an AC input voltage waveform, the method comprising:
rectifying the AC input voltage waveform to output the DC output voltage via a rectifier circuit comprising a plurality of switches;
altering one or more control signals of the plurality of switches to cause the rectifier circuit to be configured in a first mode as a voltage doubler circuit in response to a voltage level of the input voltage waveform being below a reference voltage; and
altering the one or more control signals of the plurality of switches to cause the rectifier circuit to be configured in a second mode, different than the first mode, in response to the voltage level of the input voltage waveform being above the reference voltage.

29. The method of claim 28, wherein the one or more control signals comprises a first set of control signals for a first set of the plurality of switches and a second set of controls signals for a second set of the plurality of the switches, and wherein the method further comprises further comprising altering a phase of the second set of control signals relative to a phase of the first set of control signals.

30. The method of claim 28, further comprising:
generating the input voltage waveform via a receive coupler configured to wirelessly couple power in response to an externally generated magnetic field generated by a transmitter; and
switching between the first mode and the second mode based on a sequence to cause a detectable change in a characteristic of the magnetic field for signaling to the transmitter.
